(19) United States
(12) Patent Application Publication
(10) Pub. No.: US 2011/0220016 A1
(43) Pub. Date: Sep. 15, 2011

(54) OVERSPRAY SHIELD DEVICES SUITABLE FOR USE WITH MATERIAL APPLICATION APPARATUS

(76) Inventor: Fabian Santiago, Pomona, NY (US)

(21) Appl. No.: 12/991,807

(22) PCT Filed: May 11, 2009
(86) PCT No.: PCT/US09/43470

§ 371 Date: May 31, 2011

Related U.S. Application Data
(60) Provisional application No. 61/051,989, filed on May 9, 2008.

(51) Int. Cl. B05B 15/04; B05B 1/02

(52) U.S. Cl. 118/71

(57) ABSTRACT

An overspray shield device, which is suitable for use with a material application apparatus, said overspray shield device includes a shield member and a collar member. The shield member includes a body wall having an outer surface and an inner surface defining a cavity, wherein the body wall includes a throughhole. The collar member is mounted adjacent the throughhole, said collar member configured to moveably connect the shield member to a material application apparatus.

### CROSS-REFERENCE TO RELATED APPLICATIONS

This application claims priority to, and the benefit of, International Application No. PCT/US2009/043470 filed on May 11, 2009, which claims priority to, and the benefit of, U.S. Provisional Application Ser. No. 61/051,989 filed on May 9, 2008, the disclosures of which are herein incorporated by reference in their entireties.

### BACKGROUND

1. Technical Field

The present disclosure relates to material application apparatus and, more particularly, to overspray shield devices suitable for use with material application apparatus to reduce worker exposure to overspray.

2. Discussion of Related Art

Material application methods include spray painting (sometimes also referred to as surface coating). Spray painting is a painting technique where a device sprays a material such as a paint, stain or sealer through the air onto an application target. There are different types of spray guns that are used for spray painting. These are also referred to as paint sprayers and spray applicators. For example, air spray guns of a hand-held type may be used to atomize a liquefied stream of paint under the action of pressurized air and spray the resultant paint mist onto a surface. Other types of paint sprayers include: airless, or hydraulic; air-assisted airless; hot airless; high-volume low pressure (HVLP); high-volume, stepped-down low pressure; low-pressure, low volume; thin film atomization; and electrostatic.

Overspray (spray drift) of spray material is a known health hazard of the spray coating process. Exposure to spray drift may cause skin and eye irritation. Spray drift may severely irritate and burn the eyes causing corneal injury. Inhalation of spray drift may irritate the nasal cavity, throat and lungs, or may aggravate existing chronic respiratory problems such as asthma. Inhalation, ingestion or dermal absorption of spray drift may cause tissue damage.

Particle masks may be used to protect against respirable particulate matter entrained within the spray drift. Air-purifying respirators can be used to protect workers against respiratory hazards by preventing exposure to environmental hazards such as spray drift. However, respirators or particle masks that are not used properly may fail to provide adequate protection. Protective equipment such as protective eyewear, e.g., safety glasses or goggles, may be worn to protect the eyes and face. In typical spray coating operations, overspray can land on workers or their personal protective equipment. Paint overspray may impair a worker's clear vision, which may result in a risk to the worker's safety, and may hurt the quality of the coating application. Workers may neglect precautions such as the use of protective eyewear, respirators or particle masks.

Exposure to chemical or physical hazards associated with paint spraying can lead to illness, injury, or even death. There is a need to protect workers from exposure to overspray to eliminate or minimize potential health and safety consequences to workers.

### SUMMARY

The present disclosure relates to an overspray shield device, which is suitable for use with a material application apparatus, said overspray shield device including a shield member and a collar member. The shield member includes a body wall having an outer surface and an inner surface defining a cavity, wherein the body wall includes a throughhole. The collar member is mounted adjacent the throughhole, said collar member configured to moveably connect the shield member to a material application apparatus.

The present disclosure also relates to an overspray shield device, which is suitable for use with a material application apparatus, said overspray shield device including a material application apparatus having an elongated tubular body member including a proximal end and a distal end, wherein the distal end is operably connectable with a nozzle for delivery of a material, and a collar member configured and dimensioned to be slideably coupleable to the elongated tubular body member, wherein the collar member is in fluid communication with a source of air flow.

### BRIEF DESCRIPTION OF THE DRAWINGS

Objects and features of the presently disclosed overspray shield devices will become apparent to those of ordinary skill in the art when descriptions of various embodiments thereof are read with reference to the accompanying drawings, of which:

FIG. 1 is a perspective view of an overspray shield device that includes a shield member coupled to a spray gun, according to an embodiment of the present disclosure;

FIG. 2 is a perspective view of the overspray shield device of FIG. 1, schematically illustrating various positional configurations (in phantom lines) taken by the shield member in operations, according to an embodiment of the present disclosure;

FIG. 3 is a perspective view of the overspray shield device of FIG. 1, schematically illustrating various positional configurations (in phantom lines) taken by the spray gun in operations, according to another embodiment of the present disclosure;

FIG. 4 is a perspective view of an overspray shield device that includes a shield member coupled to a spray gun, according to an embodiment of the present disclosure;

FIGS. 5A and 5B are perspective views schematically illustrating positional configurations of the shield member of FIG. 1 relative to the spray nozzle, according to an embodiment of the present disclosure;

FIG. 6 is a perspective view of an overspray shield device that includes an shield member having an opening therethrough and supplied with an air flow, according to an embodiment the present disclosure;

FIG. 7 is a perspective view of the shield member of FIG. 6 shown with an air flow supplying manifold, according to an embodiment of the present disclosure;

FIG. 8 is a perspective view of another embodiment of a shield member having an opening therethrough and supplied with an air flow, according to the present disclosure;

FIG. 9 is a perspective view of a shield member supplied with an air flow, according to an embodiment of the present disclosure;

FIG. 10 is a perspective view of an overspray shield device that includes an annular-shaped air flow supplying manifold, according to an embodiment of the present disclosure;

FIG. 11 is a perspective view of another embodiment of an overspray shield device that includes an annular-shaped air flow supplying manifold, according to the present disclosure;

FIG. 12 is a perspective view of yet another embodiment of an overspray shield device that includes an annular-shaped air flow supplying manifold, according to the present disclosure;

FIG. 13 is a perspective view of still another embodiment of an overspray shield device that includes an annular-shaped air flow supplying manifold, according to the present disclosure; and

FIG. 14 is a perspective view of an overspray shield device that includes two annular-shaped air flow supplying manifolds, according to an embodiment of the present disclosure.

### DETAILED DESCRIPTION

Hereinafter, embodiments of the presently disclosed overspray shield devices will be described with reference to the accompanying drawings. Like reference numerals may refer to similar or identical elements throughout the description of the figures. As shown in the drawings and as used in this description, and as is traditional when referring to relative positioning on an object, the term “proximal” refers to that portion of the apparatus that is closer to the user and the term “distal” refers to that portion of the apparatus that is further from the user. As used in this description, “spray” and “spray pattern” are intended to be understood in their broadest meaning to include not only those processes commonly referred to as “spray” and “spray pattern” but additionally any application technique involving the directing of a coating material across a space towards a target surface. As it is used in this description, “fluid” generally refers to a liquid, a gas or both.

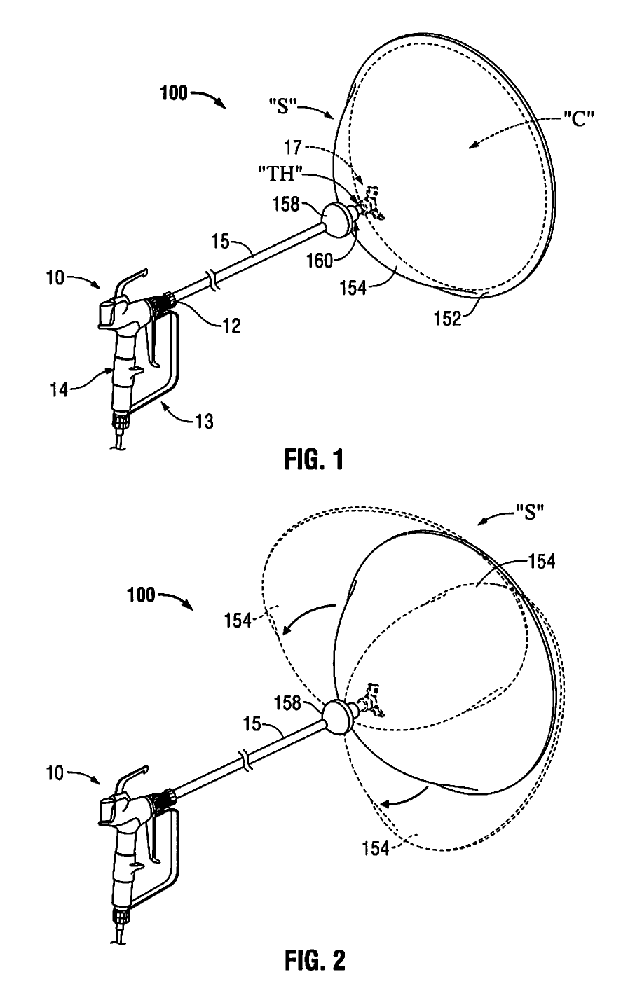

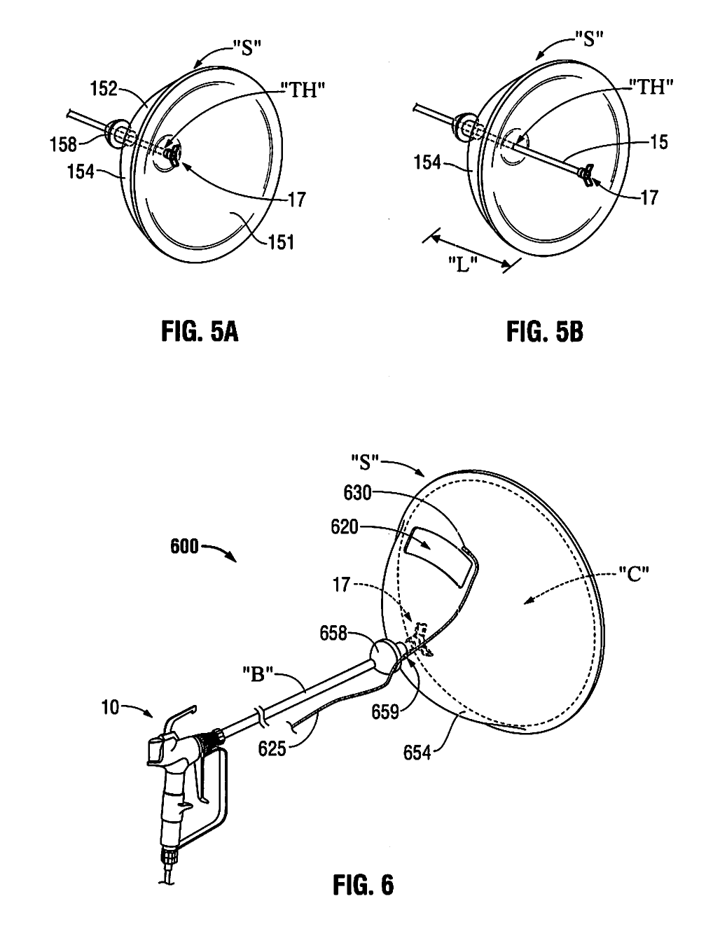

FIG. 1 shows an overspray shield device 100, according to an embodiment of the present disclosure, which includes a shield member “S” having a body wall 154 and a collar member 158. Body wall 154 may include an outer surface 152, an inner surface (e.g., 151 shown in FIG. 5A) defining a cavity “C”, and a throughhole “TH”. In FIG. 1, the overspray shield device 100 is coupled to a material application apparatus shown generally as 10. Material application apparatus 10 may be any suitable spray gun. Material application apparatus 10 (also referred to herein as spray gun 10) includes a handle portion 13 and a material delivery member 14, and may include a barrel portion 15. A connector 12 may be provided for detachably fixing the barrel portion 15 to the material delivery member 14.

In embodiments, at least a portion of the barrel portion 15 of the spray gun 10 extends through the throughhole “TH” into the cavity “C” of the shield member “S”. The distal end of the barrel portion 15 may be provided with a spray nozzle 17 capable of delivering a volume of a material, such as a coating material, e.g., paint, stain or sealer. Spray nozzle 17 may be capable of delivering a liquid coating material at 2 gallons per minute (gpm) at 3 psi pressure, with the spray pattern covering 60″ width at a distance of 18″ from the nozzle tip. Spray nozzle 17 may be capable of delivering a generally dry particulate coating material. It is to be understood that any suitable spray nozzle may be used with any suitable material to be sprayed. The shape and size of the barrel portion 15, the spray nozzle 17, the material delivery member 14, and the handle portion 13 may be varied from the configuration depicted in FIG. 1.

In embodiments, the overspray shield device 100 includes a substantially circular convex shaped shield member “S” and a collar member 158 for moveably connecting the shield member “S” to the barrel portion 15 of the spray gun 10. Shield member “S” and the collar member 158 may be releaseably or permanently coupled. In embodiments, the shield member “S” and the collar member 158 are releaseably connected together by a releasable fastener 160. Releasable fastener 160 may include a VELCRO® breakaway fastener, a quick-release fastener, or other releasable fastener. Shield member “S” may be disposable.

During a spray process, the shield member “S” may be arranged concave outward in a direction facing the target surface to which a material is to be applied. Shield member “S” may be formed of any suitable material having any suitable thickness. Shield member “S” may be formed of a substantially rigid material, such as, for example, a plastic. Shield member “S” may include a substantially transparent material. Although the body wall 154 of the shield member “S” of the overspray shield device 100 shown in FIG. 1 has a generally bell-like shape, it will be appreciated that various shapes may be utilized, including but not limited to, conical, cylindrical or disc shapes.

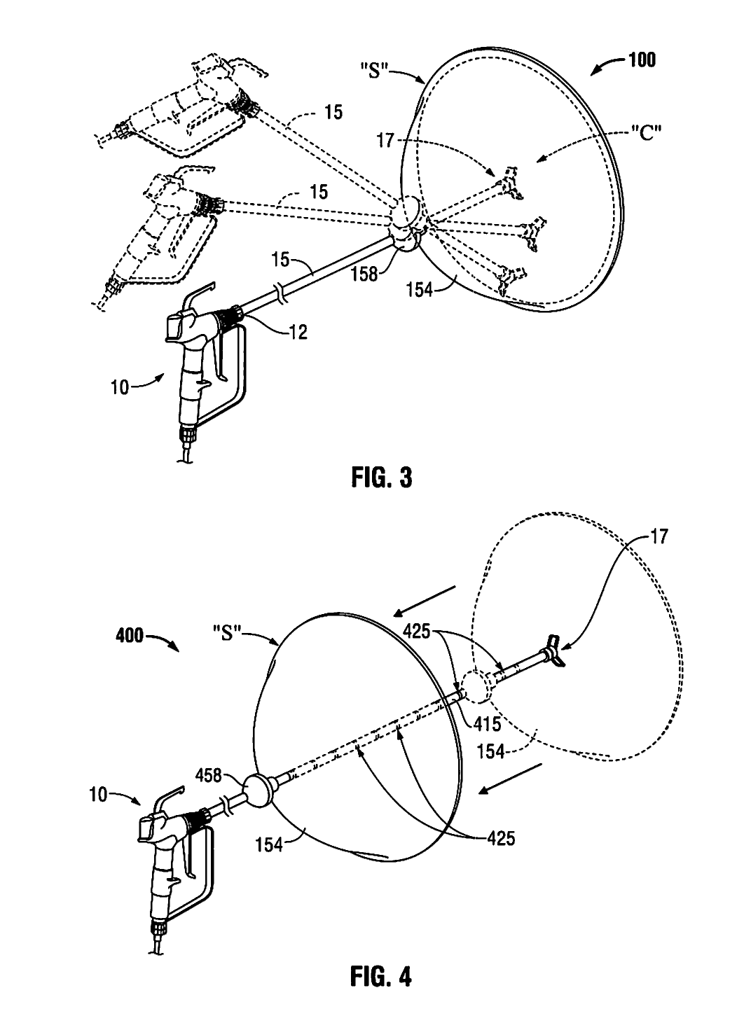

In embodiments, the orientation of the shield member “S” relative to the barrel portion 15 is adjustable. Collar member 158 may be adapted to selectively allow adjustment of the body wall 154 of the shield member “S” to any appropriate angle of tilt relative to a longitudinal axis of the barrel portion 15. FIG. 2 depicts some examples of positional configurations that may be taken by the shield member “S”. Collar member 158 may be adapted to allow movement of the spray gun 10 such that the nozzle 17 is positionable within the cavity “C” at various locations relative to the body wall 154 of the shield member “S”. FIG. 3 shows some examples of positional configurations of the nozzle 17 within the cavity “C” of the shield member “S”.

In embodiments, the overspray shield device 100 is adapted to allow a worker to adjust the spacing between the shield member “S” and the target surface without the need to change the distance between the spray nozzle 17 and the target surface. Collar member 158 may be adapted to selectively allow movement of the shield member “S” to any appropriate position along a longitudinal axis of the barrel portion 15. As shown in FIG. 5A, the shield member “S” may be positionable along the barrel portion 15 such that the throughhole “TH” is disposed substantially adjacent to the spray nozzle 17. As shown in FIG. 5B, the shield member “S” may be positionable along the barrel portion 15 such that the throughhole “TH” is spaced apart by any suitable length “L” from the spray nozzle 17.

FIG. 4 shows an overspray shield device 400, according to an embodiment of the present disclosure, which is similar to the overspray shield device 100 of FIG. 1, except for a barrel portion 415 and a plurality of engagement grooves 425 spaced apart with an equal interval disposed on an outer circumferential surface of the barrel portion 415. Collar member 458 may be adapted to selectively allow movement of the shield member “S” along a longitudinal axis of the barrel portion 415. Collar member 458 may be adapted to be releaseably engageable with the engagement grooves 425. The size, number and spacing of the engagement grooves 425 may be varied from the configuration depicted in FIG. 4. The spacing between the respective engagement grooves 425 may be based on various factors, such as a characteristic of the material to be applied (e.g., viscosity), the type of material application apparatus and/or the delivery pressure to be used. In embodiments, the barrel portion 415 of the overspray shield device 400 is replaceable.

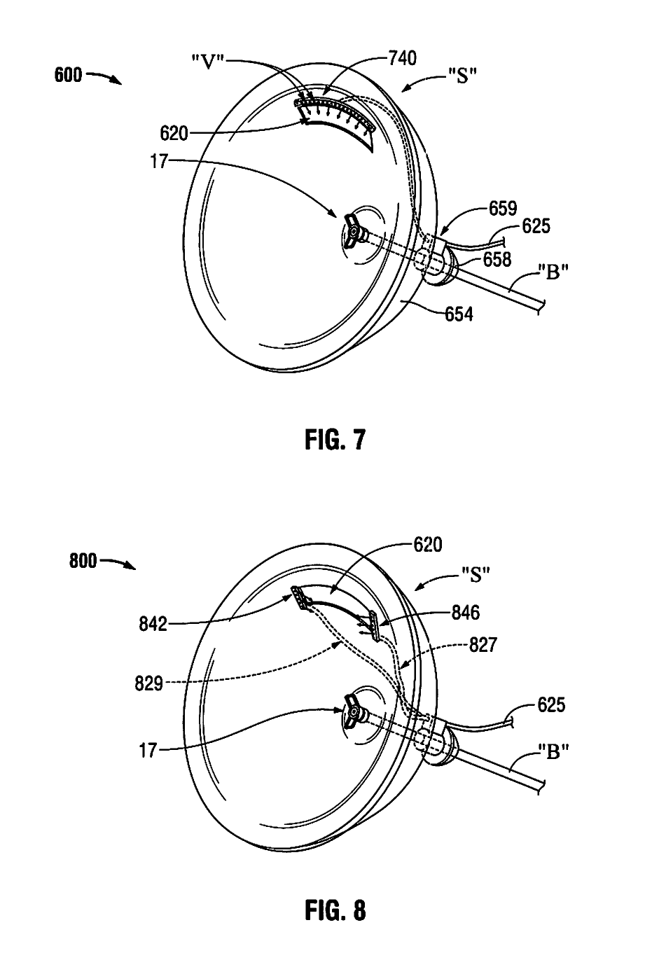

In various embodiments of the present disclosure, an overspray shield device is supplied with a flow of air across at least one opening (e.g., 620 shown in FIGS. 6 and 7) formed in a shield member “S” of the overspray shield device, which may allow a worker to view the delivery of a material to a target surface while protecting the worker from exposure to overspray. In various embodiments of the present disclosure, a substantially constant flow of air is supplied across at least one opening (e.g., 620 shown in FIG. 8) formed in a shield member “S” provided with one or more air flow supplying manifolds (e.g., 842 and 846 shown in FIG. 8). The air flow rate and/or temperature may be controllable. The source of air flow may be any suitable source of air flow, e.g., a tank of pressurized air, which may be coupled to an air compressor.

FIGS. 6 and 7 show an overspray shield device 600, according to an embodiment of the present disclosure, which includes a shield member “S” having a body wall 654 and a collar member 658 for moveably connecting the shield member “S” to a barrel portion “B”. Body wall 654 is similar to the body wall 154 of FIGS. 1 through 5B, except for an opening 620 therethrough. Shield member “S” and the collar member 658 may be releaseably or permanently coupled. In embodiments, the barrel portion “B” may be similar to the barrel portion 15 of the spray gun 10 of FIGS. 1 through 4, and the collar member 658 may be similar to the collar member 158 of the overspray shield device 100 of FIGS. 1 through 3. In embodiments, the barrel portion “B” may be similar to the barrel portion 415 of the overspray shield device 400 of FIG. 4, and the collar member 658 may be similar to the collar member 458 of the overspray shield device 400 of FIG. 4.

In embodiments, the shield member “S” is supplied with an air flow via a conduit 625. Conduit 625 may be coupled to the collar member 658. In embodiments, a portion of the conduct 625 passes through a housing 659 coupled to the collar member 658. Conduit 625 may be coupled to the collar member 658 using any suitable type of mounting device, e.g., a clip or spring fastener. Conduit 625 may be connected to an air flow supply (not shown), e.g., a pressurized air tank or compressor, to provide air flow to the fitting 630. Conduit 525 may be formed of any suitable material such as rubber hose.

In embodiments, the conduit 625 is in fluid communication with a fitting 630 coupled to the body wall 654. Fitting 630 may be fixedly attached to the body wall 654. Any suitable type of connector may be used for the fitting 630, including, but are not limited to, male-male connectors, male-female connectors, hose-hose end connectors, quick couplers, universal couplers, or other suitable air pneumatic fittings. Fitting 630 may include a mechanism to allow selective adjustment of the air flow rate, e.g., a regulating valve. In embodiments, the fitting 630 may be coupled to one or more air delivery channels, such as, for example, the air flow supplying manifold 740 illustrated in FIG. 7 or the two, air flow supplying manifolds 842 and 846 illustrated in FIG. 8. Fitting 630 may be configured to extend though an opening (not shown) in the body wall 654 to allow for the delivery of air flow to one or more air delivery channels. It will be appreciated that the fitting 630 may be integrally formed into an air delivery channel. Although the overspray shield device 600 shown in FIG. 6 includes a single fitting 630 disposed near the opening 620, it is to be understood that any arrangement of one or more fittings may be utilized. Fitting 630 may include various materials such as metal, plastic, composites or combinations thereof.

In embodiments, the body wall 654 is provided with an air flow supplying manifold 630 having a plurality of vents “V”. Air flow supplying manifold 630 is designed and configured to direct air flow across the opening 620 to substantially prevent overspray from the spray nozzle 17 from passing through the opening 620. Although the opening 620 shown in FIGS. 6 and 7 has a substantially rectangular-like shape and is arranged on the body wall 654 toward the outer peripheral edge of the shield member “S”, it will be appreciated that various shapes and arrangements may be utilized.

FIG. 8 shows an overspray shield device 800, according to an embodiment of the present disclosure, which is similar to the overspray shield device 600 of FIG. 7, except for a first air flow supplying manifold 842 and a second air flow supplying manifold 846, which are arranged on opposite sides of the opening 620, and a first conduct branch 827 and a second conduct branch 829, which couple the first and second air flow supplying manifolds, 842 and 846, respectively, to the conduit 625.

First air flow supplying manifold 842 is adapted to direct air flow in a first direction (e.g., indicated by the right-hand arrows in FIG. 8) across the opening 620. Second air flow supplying manifold 846 is adapted to direct air flow in a second direction (e.g., indicated by the left-hand arrows in FIG. 8) across the opening 620, wherein the second direction is substantially opposite to the first direction. Although the overspray shield device 800 illustrated in FIG. 8 includes two air delivery channels, i.e., air flow supplying manifolds 842 and 846, it is to be understood that the presently disclosed overspray shield devices may be configured with any number of air delivery channels. The number of air delivery channels utilized may depend on various factors, including, but not limited to, the size, shape, number and/or arrangement of the openings in the shield member.

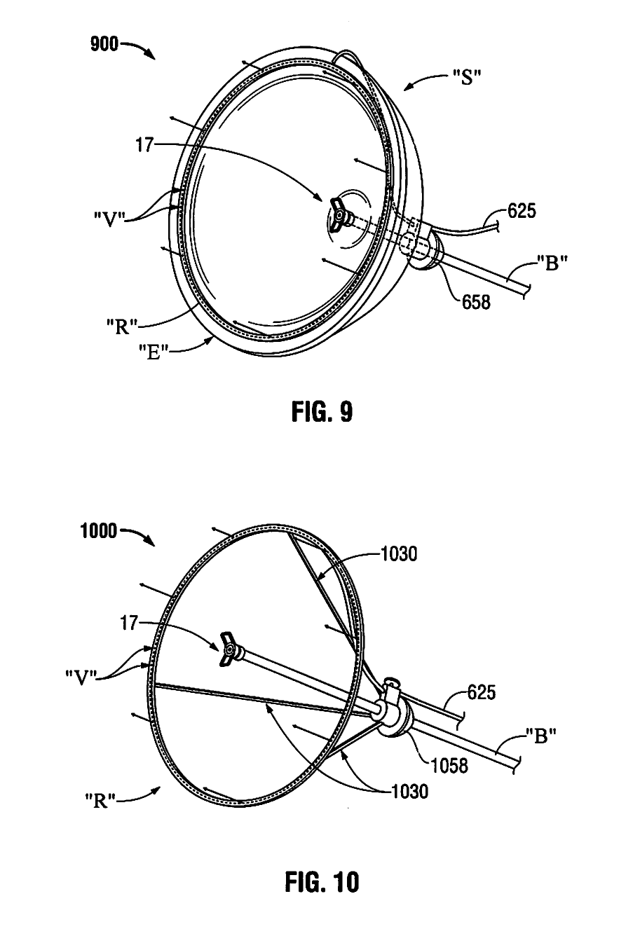

FIG. 9 shows an overspray shield device 900, according to an embodiment of the present disclosure, which is similar to the overspray shield device 100 of FIGS. 1 through 3, except for an annular-shaped air flow supplying manifold “R” having a plurality of vents “V”, which is disposed near an outer peripheral edge “E” of the shield member “S”. As shown in FIG. 9, the overspray shield device 900 may include the conduit 625, the collar member 658 and the barrel portion “B”, as were described with reference to FIGS. 6 through 8. In embodiments, the conduit 625 is in fluid communication with the air flow supplying manifold “R”.

FIG. 10 shows an overspray shield device 900, according to an embodiment of the present disclosure, which includes an annular-shaped air flow supplying manifold “R” having a plurality of vents ‘V’, a collar member 1058, and a plurality of support members 1030, which are coupled to the collar member 1058 and configured for supporting the annular-shaped air flow supplying manifold “R”. Support members 1030 may be formed of metal or other material having sufficient rigidity to support the air flow supplying manifold “R”. The size, shape, number and/or arrangement of the support members 1030 may be varied from the configuration depicted in FIG. 10.

Air flow supplying manifold “R” is coupled to an air supply line 625, which is coupled to the collar member 1158. As shown in FIG. 10, the collar member 1158 may include a mechanism 1059 to allow selective adjustment of the air flow rate, e.g., a regulating valve. In embodiments, the air flow supplying manifold “R” is configured to direct air flow in a direction (e.g., indicated by the arrows in FIG. 10) substantially perpendicular to a plane containing the annular-shaped air flow supplying manifold “R”, which may prevent overspray from the nozzle 17 from passing around the outer edge of the air flow supplying manifold “R”. It is to be understood that the size, shape, number and/or arrangement of the plurality of vents “V” may be varied to direct air flow in any suitable direction. The size and shape of the air flow supplying manifold “R” may be varied from the configuration depicted in FIG. 10.

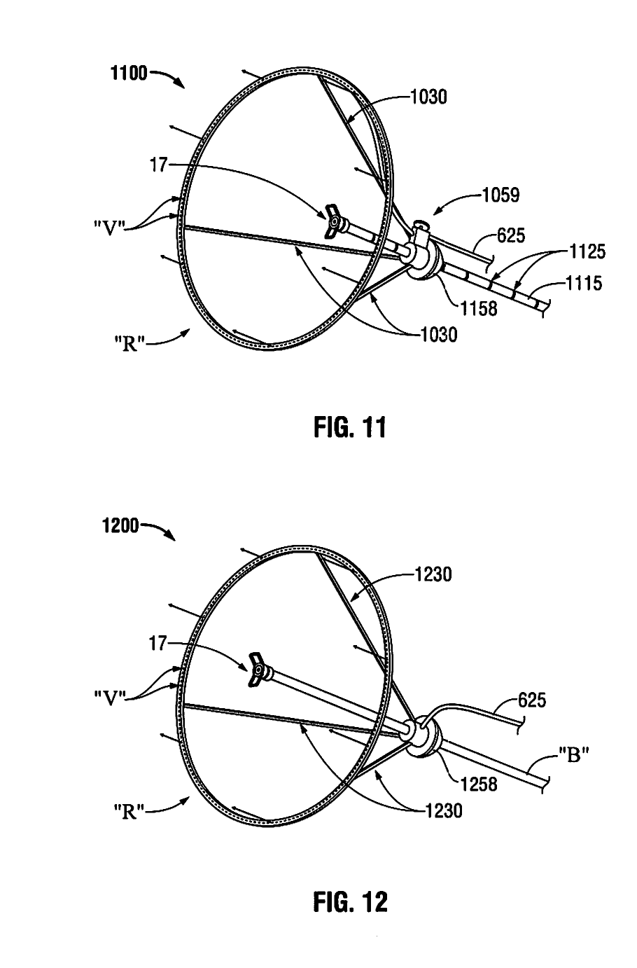

FIG. 11 shows an overspray shield device 1100, according to an embodiment of the present disclosure, including an annular-shaped air flow supplying manifold “R” having a plurality of vents “V”, which is similar to the overspray shield device 1000 of FIG. 10, except for the a barrel portion 1115 and a plurality of engagement grooves 1125 spaced apart with an equal interval disposed on an outer circumferential surface of the barrel portion 1115. Barrel portion 1115 may be similar to the barrel portion 415 of FIG. 4. The size, number and spacing of the engagement grooves 1125 may be varied from the configuration depicted in FIG. 11.

Overspray shield device 1100 includes a collar member 1158 that is adapted to selectively allow movement of the annular-shaped air flow supplying manifold “R” along a longitudinal axis of the barrel portion 1115. Collar member 1158 may be adapted to be releaseably engageable with the engagement grooves 1125. Collar member 1158 may include a mechanism 1059 to allow selective adjustment of the air flow rate, e.g., a regulating valve.

FIG. 12 shows an overspray shield device 1200, according to an embodiment of the present disclosure, including an annular-shaped air flow supplying manifold “R” having a plurality of vents “V”, which is similar to the overspray shield device 1100 of FIG. 11, except for a collar member 1258 and a plurality of support members 1230. Collar member 1258 is in fluid communication with a conduit 625. Conduit 625 may be connected to an air flow supply (not shown), e.g., a pressurized air tank or compressor, to provide air flow to the collar member 1258. At least one of the support members 1230 is adapted to provide fluid communication between the collar member 1258 and the air flow supplying manifold “R”. Collar member 1258 may include a mechanism (not shown) to allow selective adjustment of the air flow rate.

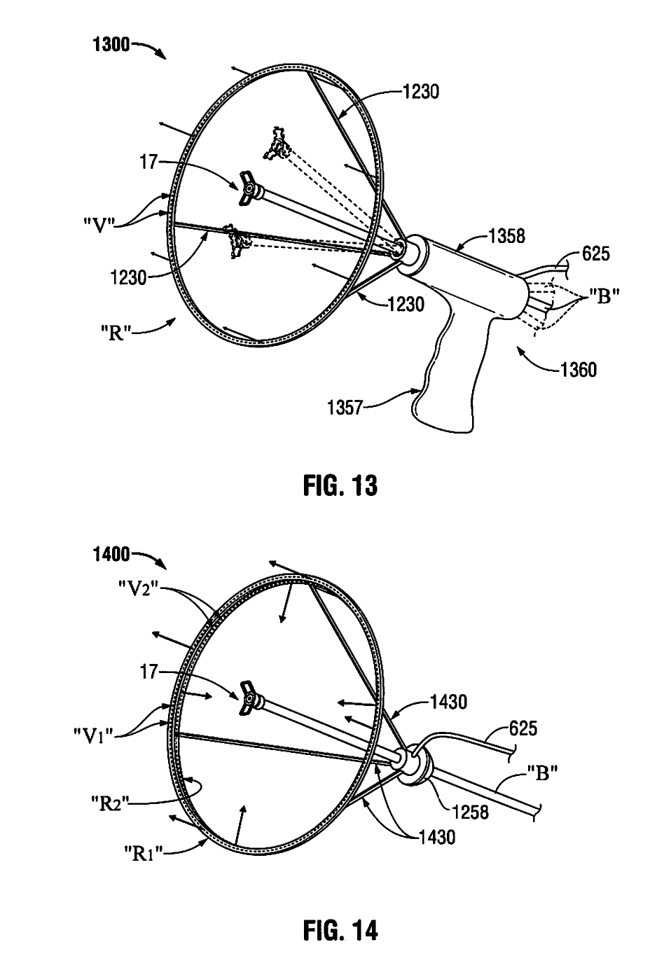

FIG. 13 shows an overspray shield device 1300, according to an embodiment of the present disclosure, including an annular-shaped air flow supplying manifold “R” having a plurality of vents “V”, which is similar to the overspray shield device 1200 of FIG. 12, except for a handle member 1360. Handle member 1360 includes a grip portion 1357 and a housing portion 1358 defining a chamber, wherein at least a portion of the barrel portion “B” is disposed within the chamber of the housing portion 1358.

In embodiments, the barrel portion “B” may be similar to the barrel portion 1115 of the overspray shield device 1100 of FIG. 11. In embodiments, the handle member 1360 may be adapted to be releaseably engageable with engagement grooves (e.g., 1125 shown in FIG. 11) disposed on an outer circumferential surface of the barrel portion “B”.

As shown in FIG. 13, the overspray shield device 1300 may include the conduit 625 and the support members 1230, as were described with reference to FIG. 12. In embodiments, the handle member 1360 is adapted to allow movement of the barrel portion “B” such that the nozzle 17 is positionable at various locations relative to a peripheral edge of the air flow supplying manifold “R”. FIG. 13 shows some examples of positional configurations of the nozzle 17 within the substantially conical-shaped region defined by the annular-shaped air flow supplying manifold “R” and the support members 1230 of the overspray shield device 1300.

FIG. 14 shows an overspray shield device 1400, according to an embodiment of the present disclosure, which is similar to the overspray shield device 1200 of FIG. 12, except for a second air flow supplying manifold “R2”. In embodiments, the overspray shield device 1400 includes a first air flow supplying manifold “R1” having a plurality of vents “V1” and a second air flow supplying manifold “R2” having a plurality of vents “V2”. First air flow supplying manifold “R1” may be similar to the annular-shaped air flow supplying manifold “R” of the overspray shield device 1200 of FIG. 12.

In embodiments, at least one of the support members 1430 is adapted to provide fluid communication between the collar member 1258 and the first air flow supplying manifold “R1”, and at least one of the support members 1430 is adapted to provide fluid communication between the collar member 1258 and the second air flow supplying manifold “R2”.

In embodiments, the first air flow supplying manifold “R1” is adapted to direct air flow in a first direction, e.g., substantially perpendicular to a plane containing the air flow supplying manifold “R1”. In embodiments, the second air flow supplying manifold “R2” is adapted to direct air flow in a second direction, e.g., generally towards the barrel portion “B”. In embodiments, the first direction may be substantially perpendicular to the second direction. It is to be understood that the size, shape, number and/or arrangement of the plurality of vents “V1” and “V2” may be varied to direct air flow in any suitable directions. The size, shape and/or arrangement of the first air flow supplying manifold “R1” and the second air flow supplying manifold “R2” may be varied from the configuration depicted in FIG. 14.

Although embodiments of the present disclosure have been described in detail with reference to the accompanying drawings for the purpose of illustration and description, it is to be understood that the inventive processes and apparatus are not to be construed as limited thereby. It will be apparent to those of ordinary skill in the art that various modifications to the foregoing embodiments can be made without departing from the scope of the disclosure.

What is claimed is:

1. An overspray shield device suitable for use with a material application apparatus, comprising:
a shield member including a body wall having an outer surface and an inner surface defining a cavity, wherein the body wall includes a throughhole; and
a collar member mounted adjacent the throughhole, said collar member configured to moveably connect the shield member to a material application apparatus.

2. The overspray shield device of claim 1, wherein at least a portion of the shield member is transparent.

3. The overspray shield device of claim 1, wherein the shield member includes a window formed therein for viewing into the cavity.

4. The overspray shield device of claim 3, wherein the window in the body wall is rectangular.

5. The overspray shield device of claim 3, wherein the shield member is supplied with air flow across the window in the body wall to substantially inhibit overspray from passing through the window.

6. The overspray shield device of claim 5, wherein the shield member includes at least one manifold for supplying the air flow across the window in the body wall.

7. The overspray shield device of claim 1, wherein the shield member and the collar member are releaseably connected together by a releasable fastener.

8. The overspray shield device of claim 1, wherein the collar member is adapted to selectively allow adjustment of the body wall of the shield member to an angle of tilt relative to a longitudinal axis of an elongated tubular body member of a material application apparatus.

9. The overspray shield device of claim 1, wherein the collar member is adapted to selectively allow movement of a nozzle of a material application apparatus within the cavity.

10. The overspray shield device of claim 1, wherein the body wall of the shield member has a generally bell-like shape defining an outer peripheral edge.

11. The overspray shield device of claim 10, wherein the shield member further includes an annular-shaped air flow supplying manifold disposed near the outer peripheral edge of the body wall.

12. The overspray shield device of claim 11, wherein the annular-shaped air flow supplying manifold includes a plurality of vents for supplying the air flow to inhibit overspray from passing around the outer peripheral edge of the body wall.

13. An overspray shield device suitable for use with a material application apparatus, comprising:
a material application apparatus having an elongated tubular body member including a proximal end and a distal end, wherein the distal end is operably connectable with a nozzle for delivery of a material; and
a collar member configured and dimensioned to be slideably coupleable to the elongated tubular body member, wherein the collar member is in fluid communication with a source of air flow.

14. The overspray shield device of claim 13, further comprising a first manifold having a plurality of vents for supplying air flow in a first direction, said first manifold coupled to the collar member.

15. The overspray shield device of claim 14, further comprising a plurality of elongated support members coupled to the collar member and extending radially outward, wherein the first manifold is coupled to the plurality of support members.

16. The overspray shield device of claim 15, wherein at least one of the support members provides fluid communication between the first manifold and the collar member.

17. The overspray shield device of claim 14, further comprising a second manifold for supplying air flow in a second direction.

18. The overspray shield device of claim 17, wherein the second direction is substantially perpendicular to the first direction.

19. The overspray shield device of claim 13, wherein the collar member further includes a mechanism to allow selective adjustment of a rate of the air flow.
